(19) United States
(12) Patent Application Publication
(10) Pub. No.: US 2008/0231184 A1
(43) Pub. Date: Sep. 25, 2008

(54) Higher efficiency incandescent lighting using photon recycling

(75) Inventors: Jae-Hwang Lee, Brookline, MA (US); Yong-Sung Kim, Latham, NY (US); Joong-Mok Park, Ames, IA (US); Kai-Ming Ho, Ames, IA (US); Kristen P. Constant, Ames, IA (US)

Correspondence Address: REINHART BOERNER VAN DEUREN P.C., 2215 PERRYGREEN WAY, ROCKFORD, IL, 61107, US

(73) Assignee: Iowa State University Research Foundation, Inc., Ames, IA (US)

(21) Appl. No.: 12/070,100

(22) Filed: Feb. 15, 2008

Related U.S. Application Data
(63) Continuation-in-part of application No. 11/455,486, filed on Jun. 19, 2006.
(60) Provisional application No. 60/911,723, filed on Apr. 13, 2007.

(51) Int. Cl. H01K 3/02; H01J 9/02

(52) U.S. Cl. 313/580; 445/27

(57) ABSTRACT

A metallic photonic crystal (MPC) structure used as a filter with incandescent lighting is presented that significantly improves efficiency, while retaining the desirable color rendering index of incandescent lighting. The resulting efficiency is higher than many existing lighting types. The MPC filter is implemented with only a single layer of square lattice or two layers of woodpile-like lattice has high reflection from the photonic band edge to infinitely long wavelength. The MPC filter can be used in a spherical, cylindrical or flat form depending on the illumination scheme.

### CROSS-REFERENCE TO RELATED PATENT APPLICATIONS

This patent application is a continuation-in-part of U.S. patent application Ser. No. 11/455,486, filed Jun. 19, 2006, the entire disclosure which is incorporated by reference in its entirety herein. This patent application also claims the benefit of U.S. Provisional Patent Application No. 60/911,723, filed Apr. 13, 2007, the entire disclosure which is incorporated by reference in its entirety herein.

### STATEMENT REGARDING FEDERALLY SPONSORED RESEARCH OR DEVELOPMENT

This invention was made in part with Government support under DOE Contract No. W-7405-Eng-82. The government has certain rights in this invention.

### FIELD OF THE INVENTION

The present invention relates generally to photonic band gap devices and more particularly to a photonic crystal structure suitable for use in light bulbs and more particularly, incandescent light bulbs

### BACKGROUND

Incandescent bulbs have been used for general lighting on the strength of the ease of fabrication and quality of the light, in spite of their low energy efficiency. However, in view of the low efficiency and the increasing global focus on green house gas emissions, incandescent lights are becoming less and less favorable in the eyes of many. More efficient alternative lighting devices are becoming increasingly common including compact fluorescent lamps and inorganic/organic light-emitting-diodes (LEDs). Legislators in California, for example, have proposed to ban incandescent light bulbs between 25 watts and 150 watts by 2012 and replace them with other types of bulbs. Even some countries have proposed banning incandescent light bulbs. Australia, for example, has indicated incandescent bulbs will be completely phased out by 2010 and replaced with the more fuel efficient compact fluorescent models which use around twenty percent of the electricity to produce the same amount of light.

FIG. 17 shows the luminous efficiencies of incandescent light and other types of lighting means where it can be seen that incandescent light is among the lowest efficient lighting. Resistance to the alternative light sources shown is largely due to the color and “comfort” of the light, i.e. the visual effect of the light on colored surfaces. This is often referred to as the color rendering index (CRI). The (CRI) is a measure of the ability of a light source to reproduce the colors of various objects being lit by the source. FIG. 18 shows the CRI plotted against typical luminous efficacy range for various types of existing general lighting means. By definition, the CRI of an incandescent bulb is nearly 100, whereas that of fluorescents are between 63 (standard fluorescents) and 80 (newer “triphosphor” lamps).

The efficiency of typical 100 W incandescent bulb can be demonstrated by FIG. 19. The blackbody radiation curve at 2800K, which is characteristic of the typical 100 W incandescent bulb, is divided into two areas. The first area, shaded to the left, represents useful visible light, and the second area (shaded to the right) is wasted as undesirable heat in most applications. Yet, incandescent lighting still possesses advantages, such as the warm white light of low color temperature that incandescent bulbs emit and easiness to dim using inexpensive controls.

There have been many attempts made to improve efficiency of the incandescent bulb, beginning as far back as 1912. A common approach is to attempt to recycle wasted infrared (IR) radiation to be reemitted as visible. Prisms and mirrors, layered reflection filters, and multilayer dielectric filters have all been used in this effort.

The attempt to increase the energy efficiency of conventional incandescent light bulb by a multilayer interference filter has been tried. The interference filter, often called a hot mirror, can reflect infrared and transmit visible light selectively. FIG. 20 shows an example of a filter that consists of 46 pairs of Ta₂O₂/SiO₂ layers. The models for power reduction due to IR filters include the reflectivity of the filter, the emissivity of the filament, and the fraction of reflected radiation from the filter which is reabsorbed by the filament fa. The fraction of reflected radiation from the filter which is reabsorbed by the filament fa is given by:

$$fa = {\int }_{λ}^{ } \frac{{a}_{λ} {GR}_{λ} {S}_{λ}}{1 - ( 1 - {a}_{λ} ) {GR}_{λ} {S}_{k}} d λ$$

where α_{λ} is the coil aborptivity, G is the geometrical gain factor indicating the fraction reflected IR back to the filament, R_{λ} is the specular reflectivity of the film, and Sₖ is the specularly reflected radiation strikes the filament due to radially and/or axial offset from the optical axis. Including radiation reabsorbed by second reflection from the filter,

Sₖ=1−k+kGR

where k is the fractional radial offset of the filament.

In 1995, The Optical Society of America sponsored a contest for a better hot mirror to improve the efficiency of tungsten lamps constraining the number of layers, the incident medium (air), the substrate and four specific dielectric materials. FIG. 21 shows the designed refractive index profiles of the eight best designs (as measured by calculation). The problem with interference filters such as hot mirrors is that they require sophisticated multilayer structures because of low refractive-index-contrast. Additionally, they have a limited infrared-reflecting range, for example the multilayer filter in FIG. 20 shows reflecting range from 0.75 μm to 2 μm.

### SUMMARY

The apparatus described herein significantly improves efficiency, while retaining the desirable CRI of incandescent lighting as compared with other existing general lighting means.

The apparatus provides an alternative to interference filters that is easier to manufacture and is lower cost. The apparatus is a metallic photonic crystals (MPC) that has high reflection from a certain wavelength, called a photonic band edge, to infinitely long wavelength, with only a single layer of square lattice or two layers of woodpile-like lattice. The apparatus transmits useful visible light and returns undesired infrared light back to the filament of the incandescent light. The returned infrared light is used to heat the filament, thereby reducing the amount of input energy required to maintain the temperature of the filament.

Other advantages of the invention will become more apparent from the following detailed description when taken in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings incorporated in and forming a part of the specification illustrate several aspects of the present invention, and together with the description serve to explain the principles of the invention. In the drawings:

FIG. 1a is a top view of a 2-D square mesh metallic photonic crystal (MPC);

FIG. 1b is an isometric view of a MPC design;

FIG. 2 is a graph illustrating thermal radiation of an incandescent light with and without the MPC design of FIG. 1b;

FIG. 3 is a CIE chromaticity diagram of an incandescent light with and without the MPC design of FIG. 1b;

FIG. 4 is an illustration of calculated luminous efficiency of an incandescent light with an MPC at 2800K compared with other types of lighting means;

FIG. 5 is a graph showing the CRI of the MPC incandescent light plotted against typical luminous efficacy range along with various types of existing general lighting means;

FIG. 6 is a chromaticity diagram illustrating the tuning range of color using an MPC filter with different periodicities and opening widths for an incandescent source at 2800K;

FIG. 7 is a chromaticity diagram illustrating the range of colors that can be tuned using an MPC filter with different periodicities and opening widths for an incandescent source at 2800K;

FIG. 8 is a graph illustrating how different periodicities and opening widths affects the radiation power versus wavelength;

FIG. 9a is a cross sectional view of a spherical or cylindrical MPC filter for radially isotropic illumination;

FIG. 9b is a cross sectional view of a flat MPC filter with a parabolic mirror;

FIGS. 10a-10g are schematic illustrations of a two-polymer microtransfer molding process used to fabricate a MPC filter;

FIGS. 11a-11d are scanning electron micrographs of a freestanding two-layer nickel MPC structure at different magnifications;

FIG. 12 is a graph illustrating the optical transmission spectrum of the MPC filter of FIGS. 11a-11d;

FIG. 13 is an illustration of an MPC fabrication process using interference holography with positive photoresist;

FIG. 14a is a graph illustrating calculated reflectance, transmittance, and absorbance of an MPC filter having a lattice constant of 350 nm, an air opening of 250 nm and a thickness of 500 nm;

FIG. 14b is a graph illustrating calculated reflectance, transmittance, and absorbance of an MPC filter having a lattice constant of 400 nm, an air opening of 300 nm and a thickness of 500 nm;

FIG. 14c is a graph illustrating calculated reflectance, transmittance, and absorbance of an MPC filter having a lattice constant of 500 nm, an air opening of 400 nm and a thickness of 500 nm;

FIG. 15a is a graph of incandescent light source output spectra after MPC filtering using the MPC filter of FIG. 14a, luminous flux, and blackbody radiation;

FIG. 15b is a graph of incandescent light source output spectra after MPC filtering using the MPC filter of FIG. 14b, luminous flux, and blackbody radiation;

FIG. 15c is a graph of incandescent light source output spectra after MPC filtering using the MPC filter of FIG. 14c, luminous flux, and blackbody radiation;

FIG. 16 is a graph of chromaticity color coordinates where the coordinates of the MPC-filtered lights using the MPC filters of FIGS. 14a-14c and a blackbody at 2800 K are plotted.

FIG. 17 is an illustration of calculated luminous efficiency of an incandescent light at 2800K compared with other types of lighting means;

FIG. 18 is a graph showing the CRI of an incandescent light plotted against typical luminous efficacy range along with various types of existing general lighting means;

FIG. 19 is a graph illustrating blackbody radiation at 2800K with visible light and infrared radiation illustrated;

FIG. 20 is a graph illustrating an example of the optical characteristics of a prior art interference filter that consists of forty six pairs of Ta₂O₂/SiO₂ layers; and

FIG. 21 is a graph illustrating designed refractive index profile of eight of the best prior art hot mirror designs submitted to the Optical Society of America in a contest for a better hot mirror.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

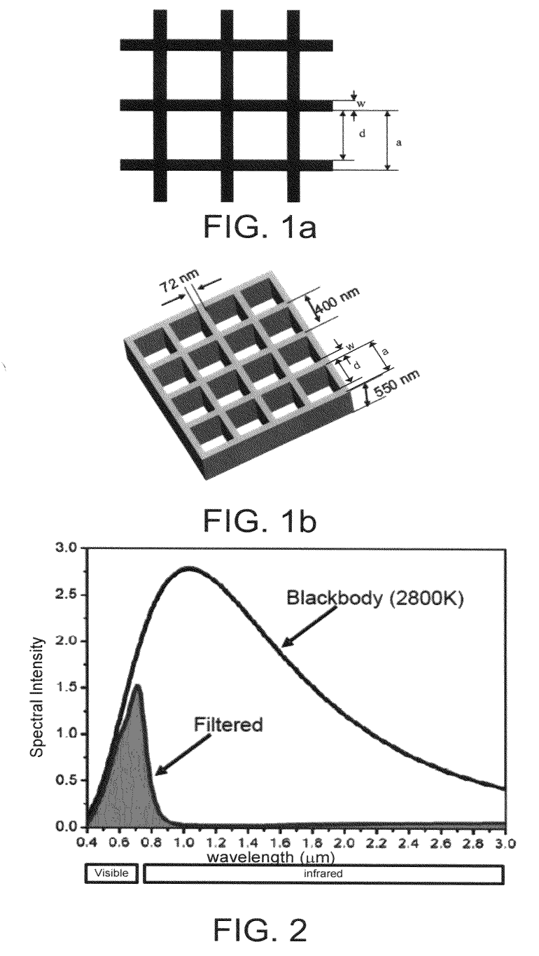

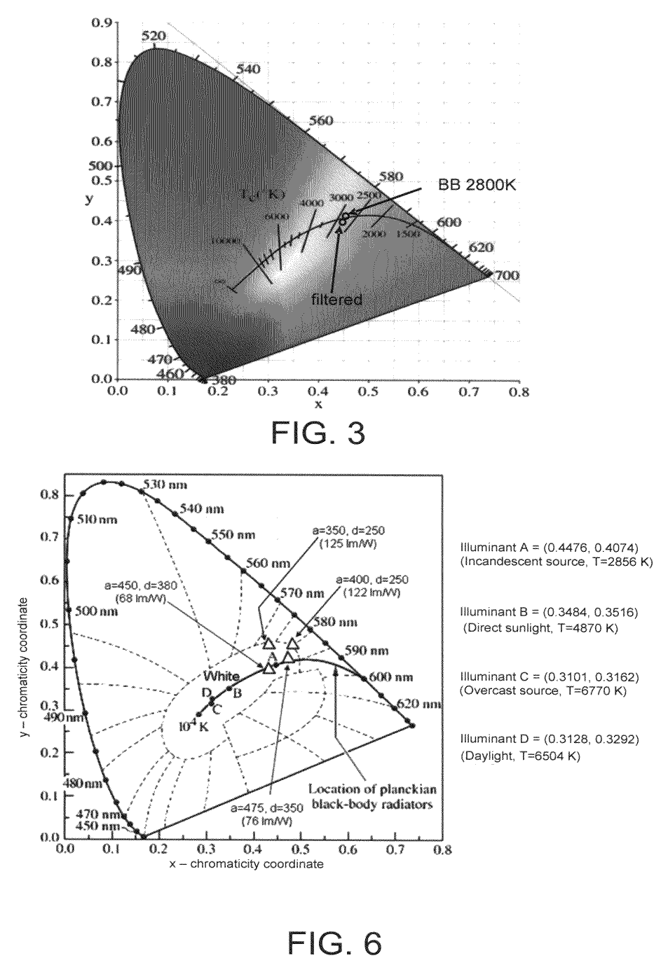

The apparatus described herein provides an alternative to interference filters that is easier to manufacture and is lower cost. A metallic photonic crystal (MPC) that has high reflection from a certain wavelength, called a photonic band edge, to infinitely long wavelength, with only a single layer of square lattice or two layers of woodpile-like lattice is used. Metallic photonic crystals are periodic metallic structures that exhibit frequency regions, called photonic band gaps, in which electromagnetic waves cannot propagate. Photon behavior is similar to the behavior of electrons in a semiconductor. The periodic arrangement of atoms opens up forbidden gaps in the energy band diagram for the electrons. This characteristic makes MPCs unique for use. Additionally, the transmittance for visible light can be increased by engineering the geometry of MPCs. An example of a MPC design is illustrated in FIG. 1a and FIG. 1b where a is the periodicity, d is the opening width, and w is the width of the “bars.” In FIG. 2, a graphical representation of thermal emission with and without the MPC design of FIG. 1b is shown. Without the MPC, it can be seen that the infrared portion is wasted as heat. With the MPC, all or nearly all of the infrared portion of light is blocked (depending on the MPC geometry) and reflected back to the tungsten filament and the visible portion of light is barely affected. As a result, the color of filtered light is not altered much from that of the original blackbody in CIE chromaticity diagram in FIG. 3. In FIG. 3, the color of a blackbody at 2800K without a MPC is labeled “BB 2800K” and the color of the blackbody at 2800K with the MPC is labeled “filtered.”

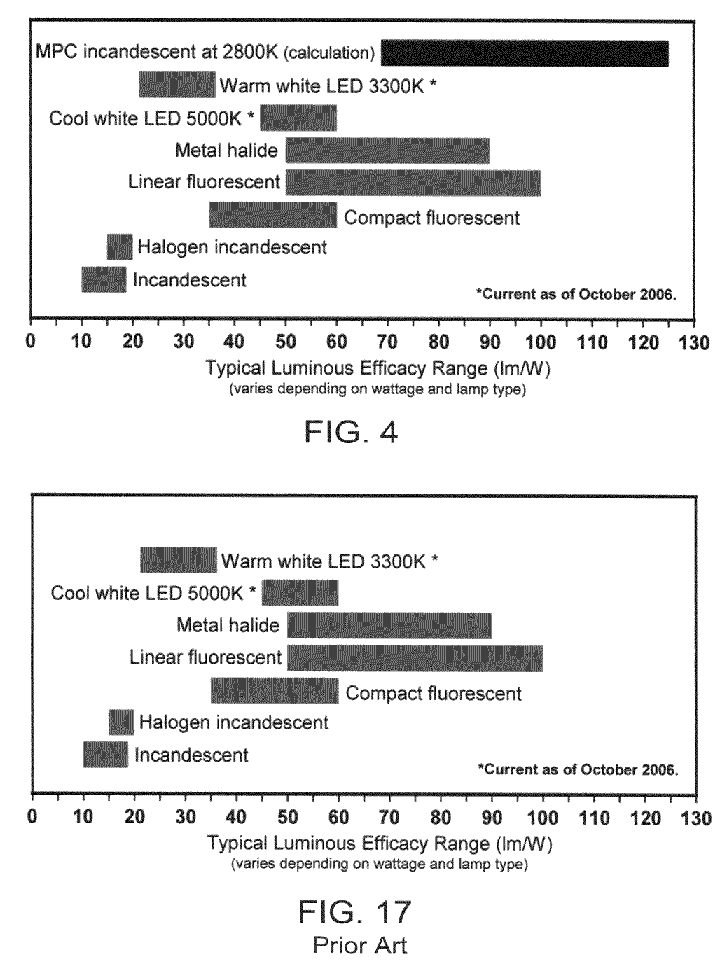

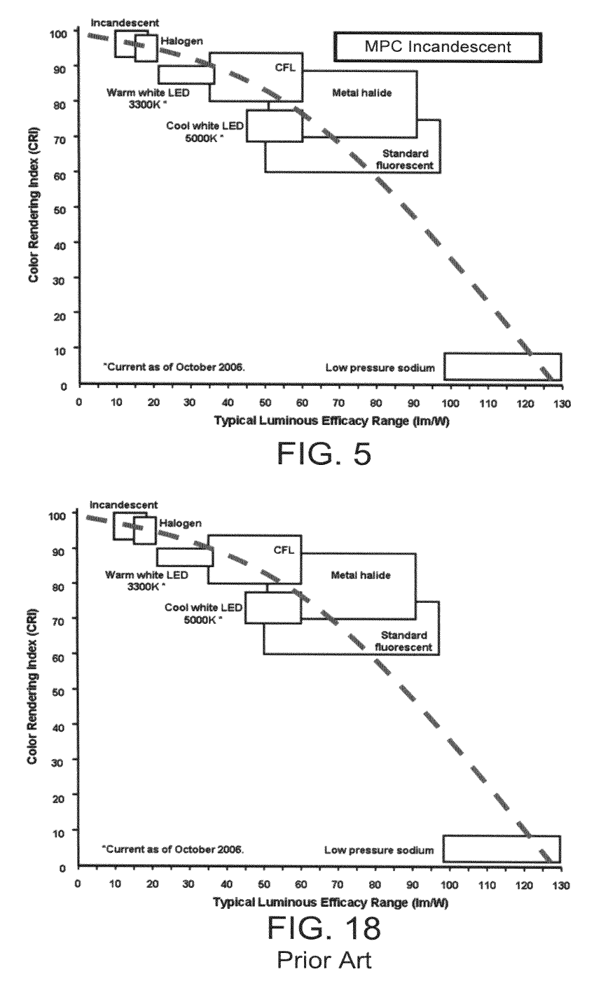

FIG. 4 shows the calculated luminous efficiency of an incandescent light with an MPC at 2800K compared with other types of lighting means where it can be seen that MPC incandescent light is among the highest efficient lighting. Similarly, FIG. 5 shows the CRI of the MPC incandescent light plotted against typical luminous efficacy range along with various types of existing general lighting means. Ordinarily, a high color rendering index (defined as 100 for a 100 W incandescent bulb) is correlated to low efficacy (lumens/watt) because the broad spectrum light associated with sunlight and with incandescent bulbs which produces the best “color” also results in significant loss in the non-visible portion on the spectrum. However, with the MPC, the structure can be tuned such that photons in the non-visible range are recycled for re-emission in the visible range. This preserves the CRI of a broad spectrum source, while vastly improving efficacy. It can be seen from FIG. 5 that the MPC incandescent has the same or similar CRI as an incandescent light while having one of the highest luminous efficacy range.

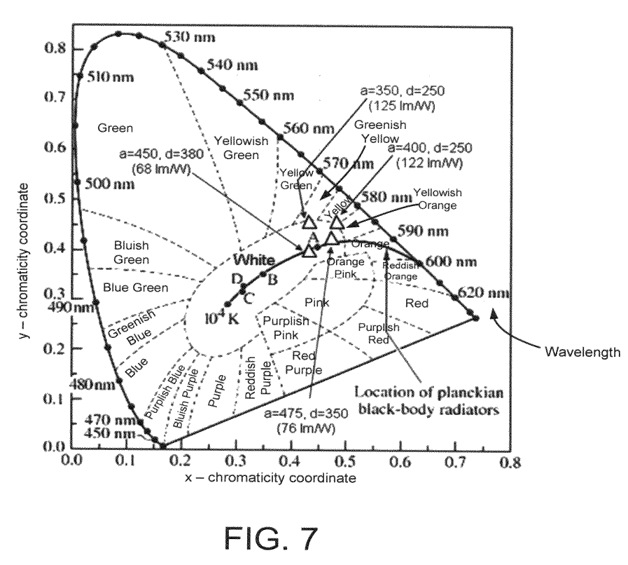

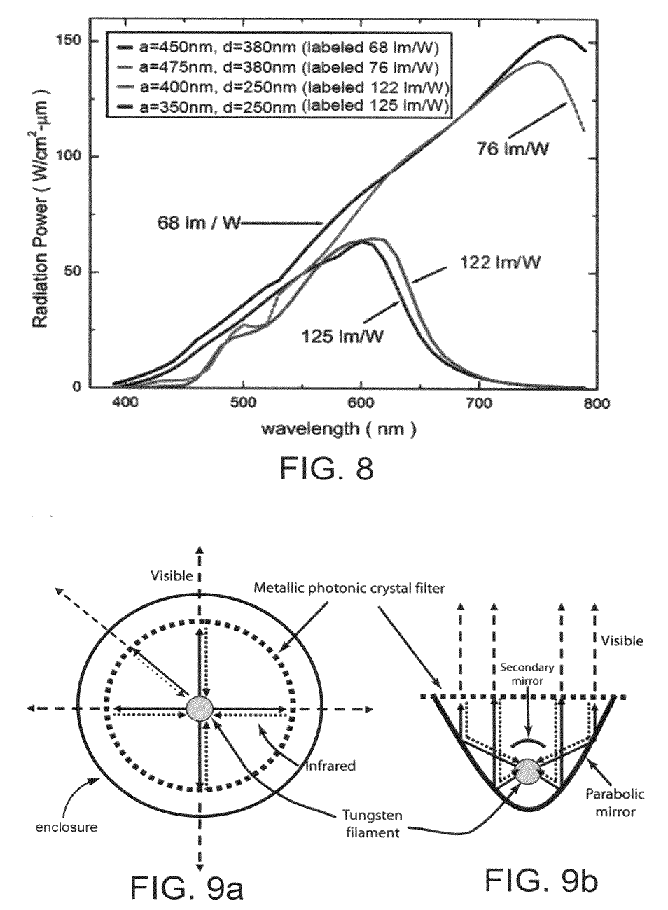

The chromaticity diagram shown in FIG. 6 illustrates the tuning range of color by using an MPC filter having different periodicity, a, and opening width, d. Since an incandescent source at 2800K is used as a baseline, all tuned colors are around the point A, which is the incandescent source at 2856K. The middle area in the diagram represents white color. Two filtered lights are in the white region and the rest are in the transition region from white to yellow. The color of each section is shown in FIG. 7. Note that the tuning range is not limited to the examples shown in these figures. FIG. 8 illustrates how different periodicities and opening widths affects the radiation power versus wavelength.

The MPC filter can be used in a spherical, cylindrical or flat form depending on the illumination scheme. FIG. 9a shows a cross section of spherical or cylindrical MPC filter for radially isotropic illumination. Because the direction of emitting light is approximately perpendicular to the MPC filter, the infrared portion of the light from the tungsten filament is reflected back to the filament and only the visible portion of the light transmits out of the filter. Energy is saved as much of the infrared energy that would normally be lost is reflected back to the filament, which results in a hotter filament, thereby requiring less energy to operate the filament. In general, a spherical or cylindrical MPC filter in some embodiments may be more difficult to fabricate than a flat MPC filter. This difficulty can be relieved by employing a parabolic mirror as seen in FIG. 9b. In this configuration, a parabolic mirror and spherical secondary mirror redirect light from the filament such that the light is approximately perpendicular to the flat MPC filter. The configuration in FIG. 9b can be used not only for directional illumination but also for diffused illumination with an additional diffuser outside of the bulb. For purposes of clarity, the enclosure (e.g., glass) that is used to seal the filament and provide power connections to the filament is not shown in FIG. 9b. Note that the MPC is far enough from the filament such that the MPC temperature is smaller than its melting temperature.

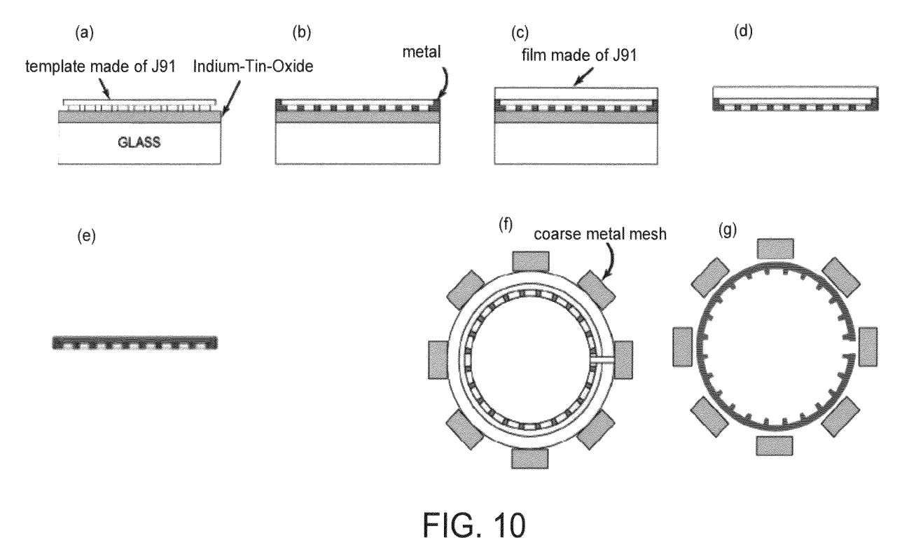

The MPC filter can be fabricated several ways. One of the ways is by two-polymer microtransfer molding. Turning now to FIGS. 10a-10g, the overall steps to create a MPC filter by two-polymer microtransfer molding is shown. In two-polymer microtransfer molding, a two-layer polymer template is fabricated on a conductive substrate such as, for example, an indium-tin-oxide (ITO) coated glass (see FIG. 10a). A photo-curable prepolymer (e.g., J91, Summers Optical) is used for the structural material and the ITO layer works as a cathode in electroplating. In one embodiment, the two-layer polymer structure is fabricated by filling a plurality of grooves of an elastomeric mold with a first polymer that can be UV cured. Each groove in the plurality of grooves are in parallel with each other. The first polymer is partially cured and a second polymer is coated on the first polymer, resulting in the elastomeric mold being filled. The conducting substrate is placed on the filled elastomeric mold and the conducting substrate and the filled elastomeric mold are exposed to UV light. The filled elastomeric mold is peeled away from the first polymer and the second polymer such that the first polymer and second polymer form a polymer layer of polymer rods on the conducting substrate. The process is repeated with the second layer (the first layer attached to the conducting substrate is placed on the filled elastomeric mold) and subsequent layers if needed to form the multi-layer polymer structure (e.g., the two-layer polymer structure). The resulting polymer structure forms channels between the polymer rods.

A commercially available electrodeposition electrolyte kit (e.g., Bright nickel, Caswell) is used without modification for the electrodeposition of nickel (see FIG. 10b). Other methods may be used. The ITO-coated glass substrate (8-12 ohms, SPI) is sonicated in a water-based detergent for an hour and thoroughly rinsed with distilled water. The template is submerged into the electrolyte in a chamber and the surrounding pressure is subsequently reduced to a level where the electrolyte starts to boil at room temperature and then recovered to atmospheric pressure. After 10 cycles of depressurization, it was observed that the polymer template wets completely. The pressure cycling has two effects: first, release of the captured air in the template by volume expansion; second, depletion of dissolved air in the electrolyte because of lower gas solubility at lower pressure. After wetting occurs, the electroplating is performed at room temperature with a current density 0.15 mA/mm² until the metal being filled reaches the top of the template.

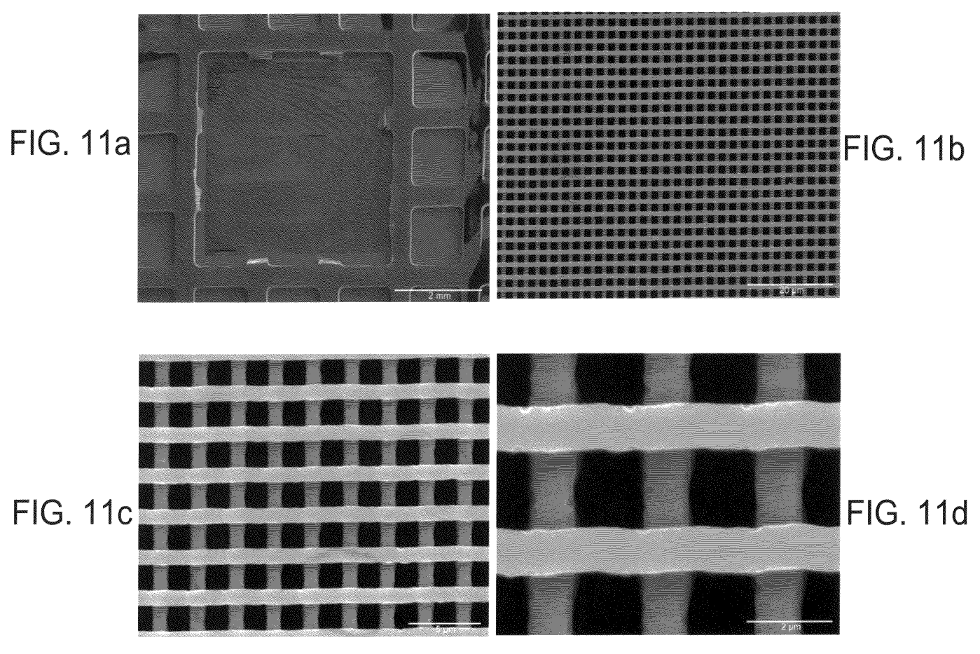

J91 is spun on the metal-infiltrated template at 4000 RPM for 1 minute and is exposed to ultraviolet light (at a wavelength of 366 nm) to solidify it, resulting in few tens of microns of homogeneous back-film formed (see FIG. 10c). The back-film is used to support the metal structure during the step of peeling off the structure from the ITO coated glass. Other methods may be used to provide support if needed. The backfilled template with the back-film is peeled off the ITO coated glass (see FIG. 10d). The homogeneous and thick J91 back-film reinforces the mechanical strength of the template to more easily peel the backfilled template off the ITO coated glass. For a flat MPC filter (see FIG. 10e) such as the MPC filter illustrated in FIG. 9b, the peeled film is submerged in potassium hydroxide solution (40% in weight). For a cylindrical MPC filter, the peeled film is rolled and inserted in a coarse cylindrical metal mesh (see FIG. 10f). Similarly, for a spherical MPC filter, the peeled film is formed over a coarse spherical mesh (not shown). The structures are submerged in potassium hydroxide solution (40% in weight) for 10 minutes to dissolve the template (and the homogeneous back-film). After rinsing, the structure is dried, resulting in the structures seen in FIGS. 10e and 10g. Further details on the two-polymer microtransfer molding technique is in U.S. patent application Ser. No. 11/455,486, hereby incorporated by reference in its entirety. A two-layer nickel MPC structure is shown in FIGS. 11a-11d and is mounted on a flat mesh. The two-layer nickel structure is shown at different magnification. In FIGS. 11a-11d, each rod (also called a bar) is 1.1 μm wide and 1.2 μm high. The rod-to-rod distance is 2.6 μm.

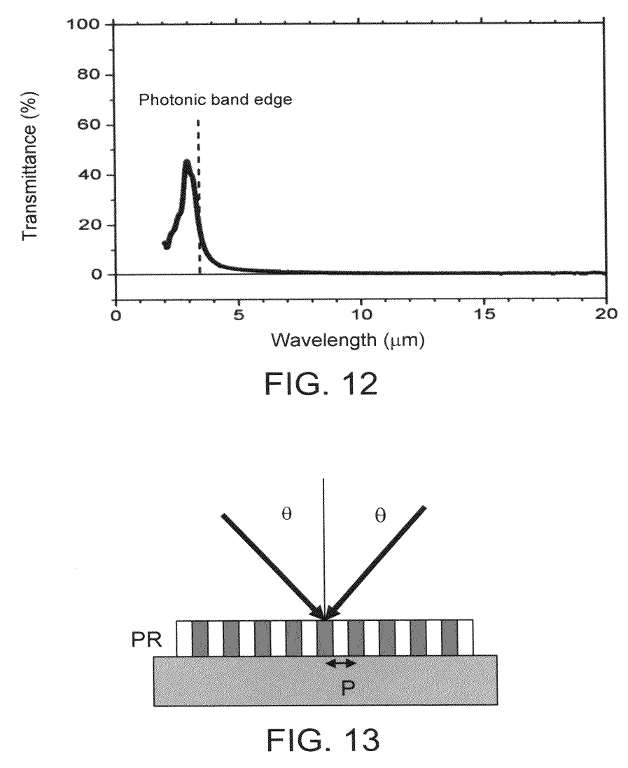

The transmittance of the MPC filter can be measured by a Fourier-transform infrared spectrometer. The characteristic photonic band edge of the MPC filter shown in FIGS. 11a-11d is shown in FIG. 12 and appears at 3.5 μm where transmission drops close to zero for longer wavelengths. Note that by using thinner widths of the metallic bars, the transmittance of the structure can increase. It is calculated that the transmission increase can be as much as ninety percent depending on the width of the metallic bars. Scaling of the prototype filter will shift the photonic band edge toward the visible range.

To achieve submicron length scales, a different approach for fabricating the metallic structure is used. Turning now to FIG. 13, interference holography is cost effective way to make structures over a large area. In this method, an Ar-ion ultraviolet laser with a 364 nm wavelength is used to produce a periodic pattern on photosensitive materials. Other types of lasers at different wavelengths may be used. The laser beam is split by a beam splitter to expose photoresist that has been spincoated on transparent ITO glass. After developing to remove channels of material that have not been crosslinked by exposure to the laser, the photosensitive material has a periodicity P that depends on the angle of incidence θ and wavelength λ:

$$P = \frac{λ}{2 sin θ}$$

The empty channels in the periodic patterns are backfilled with metal by electrodeposition. The height of the metal can be controlled through adjustment of the deposition time. The process is repeated to build a second layer with 90 degree rotation to fabricate a two layer structure. The photoresist is removed to yield the metallic photonic crystal structure. Note that the metallic mesh can also be generated by other techniques (e.g., standard photolithography).

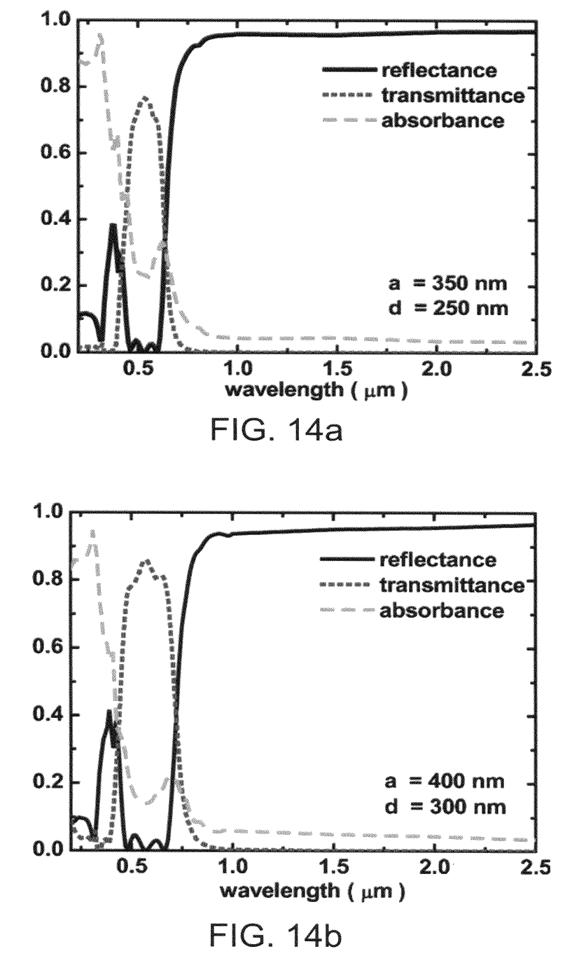

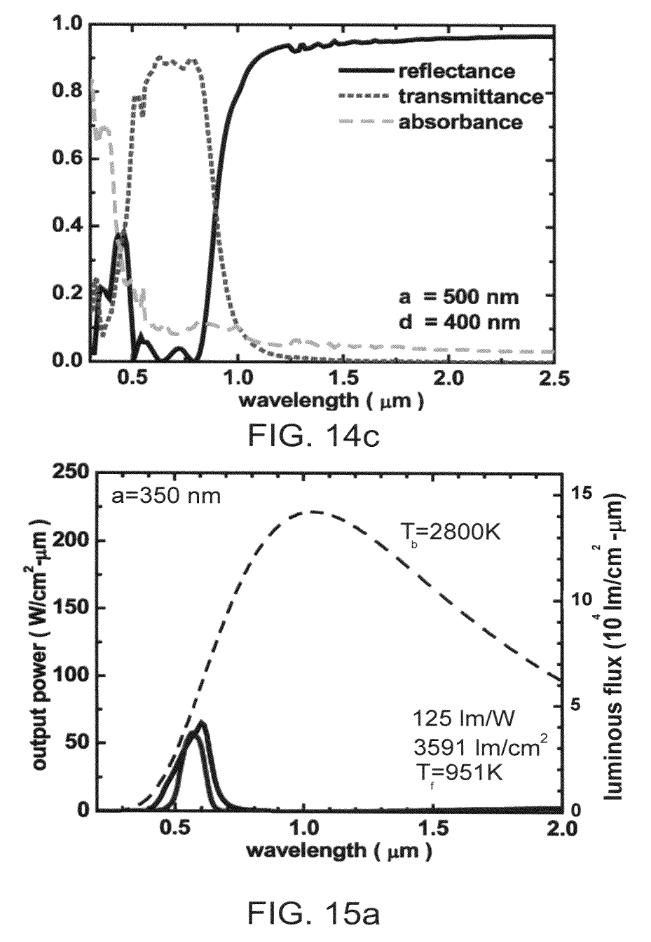

Turning now to FIGS. 14a-14c. calculated optical properties of a two dimensional MPC filter chosen to recycle the otherwise wasted infrared photons are shown. Silver is selected as the metallic material, because it has a low intrinsic absorption in the visible and near infrared wavelengths. Other metallic materials may be used. The property of low absorption is the key to simultaneously achieving a high filter transmittance in the visible and a high filter reflectance in the infrared. To calculate the optical properties of the MPC filter such as reflectance, absorbance, and transmittance, the transfer matrix method (TMM) as described in the article by Z. Y. Li and L. L. Lin, in Phys. Rev. E 67, 046607 (2003) and realistic refractive index values are used.

Three different configurations of the MPC filters were selected to examine. To select them waveguide cutoff wavelength were considered, which is twice the air opening dimension. The selected configurations are a₁=350 nm and d₁=250 nm, a₂=400 nm and d₂=300 nm, and a₃=500 nm and d₃=400 nm, respectively. Here a is the lattice constant and d is the size of the air opening (see FIGS. 1a and 1b). The thickness of the MPC filters is h=500 nm. The calculated optical properties of the three filters are shown in FIGS. 14(a)-14(c), respectively. All three filters exhibit a high reflectance (the solid curve) in the infrared and a high transmission band (the dotted curve) in the visible.

In FIG. 14(a), the transmission line shape, tr_{f}(λ), follows closely the Gaussian function, which is consistent with that of an ideal filter. Also, the absorptance spectrum (the dashed curve), abs_{f}(λ), has a finite value of ˜20% in the visible and ˜5% in the infrared. This absorption heats up the filter and contributes to heat loss. These computed curves, tr_{f}(λ) and abs_{f}(λ), are used as the input parameters for calculating the radiation power spectrum S(λ, T_{b}), the luminous flux, and the luminous efficiency. In the calculation, the temperature of the blackbody filament is assumed to be T_{b}=2800 K. The ratio of the radius of the filament, r_{b}, and the radius of the filter, r_{f}, is 1:12.

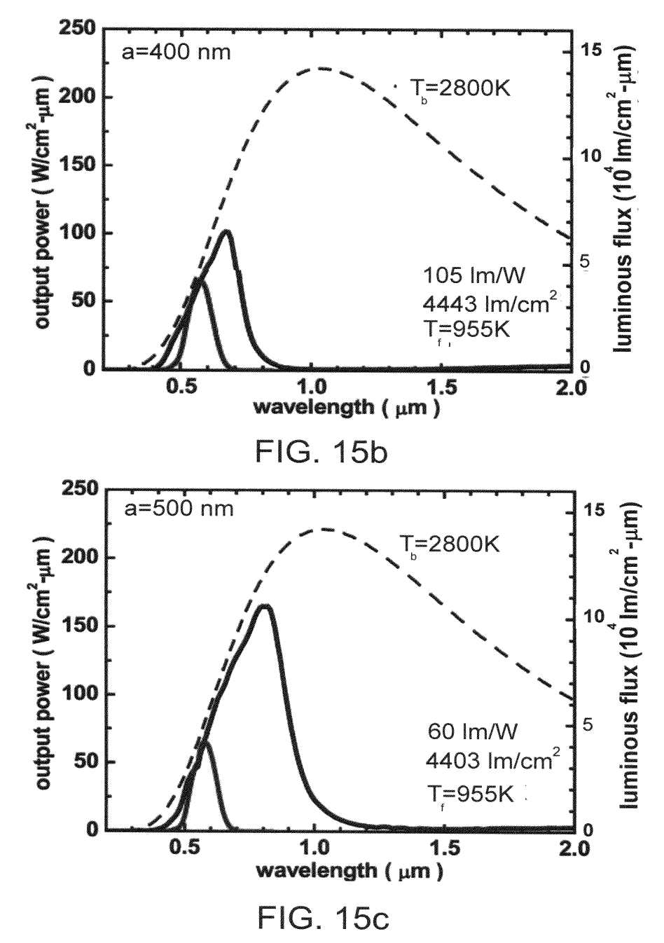

Turning to FIGS. 15a-15c, the filtered power spectrum, the luminous flux, along with a blackbody radiation curve at T_{b}=2800 K are shown for each of the three filters. The black solid curves are output spectra after filtering (i.e., filtered spectrum), the black dashed curve is a blackbody radiation at 2800 K, the assumed temperature of the incandescent filament, and the gray solid curves are luminous flux. Tf is the temperature of the filter. In FIG. 15(a), the luminous flux curve (the grey solid curve) follows closely the filtered power spectrum (the black solid curve). This is because there is a good matching between the filtered spectrum and the luminous function, V(λ). For this filter configuration, the calculated luminous efficiency and flux per unit area of the filament are 125 lm/W and 3591 lm/cm², respectively. In FIG. 15(b), S(λ, T_{b}) starts to deviate from the luminous flux curve. As a result, the calculated luminous efficiency is slightly lower (105 lm/W). However, the luminous flux increases to 4443 lm/cm². In FIG. 15(c), the deviation becomes larger and the corresponding luminous efficiency and flux are 60 lm/W and 4403 lm/cm². The calculated temperatures of the filters are 951 K, 955 K, and 955 K for a=350 nm, 400 nm, and 500 nm, respectively. These values are lower than the melting temperature of silver, 1234.9 K.

The discrepancy in the luminous efficiency between an ideal filter and the realistic MPC filter is due to the finite absorptance of the MPC filter. Particularly, the second term in the total radiation power spectrum, S(λ, T_{b}), through an ideal enclosure is the sum of the transmitted power through the filter and the outward radiated power from the heated filter

S(λ,T_{b})dλ=[A_{b}tr_{f}(λ)u(λ,T_{b})+A_{f}abs_{f}(λ)u(λ,T_{f})]dλ

contributes to an infrared loss as the filter's radiation is centered at λ˜3 μm. For the filters, this absorption loss consumes a significant portion of the total input power, 40%-67%, and hence reduces the luminous efficiency. To achieve a much higher efficiency of >200-400 lm/w, the material loss must be overcome. However, comparing with the luminous efficiency of the blackbody at 2800 K, 16 lm/W, the proposed MPC filters can still improve the luminous efficiency by up to 8 times.

Note that for general purpose illumination, not only high efficiency but also the color quality is important in evaluating a light source. The color quality of a light source can be characterized by three parameters, namely, correlated color temperature (CCT), color chromaticity, and color rendering index (CRI).

CCT is a way to assign a color temperature to a color near but not on the Planckian locus. CCT is also generally used to categorize color tone. If CCT is lower than 3300 K, the color is categorized as warm tone and if CCT is higher than 5300 K, the color is categorized as cool tone. The calculated CCTs for the filtered lights are 3547 K, 2749 K, and 2474 K for MPC with a=350 nm, 400 nm, and 500 nm, respectively. The calculated CCTs imply that the filtered lights are warm tone or close to it.

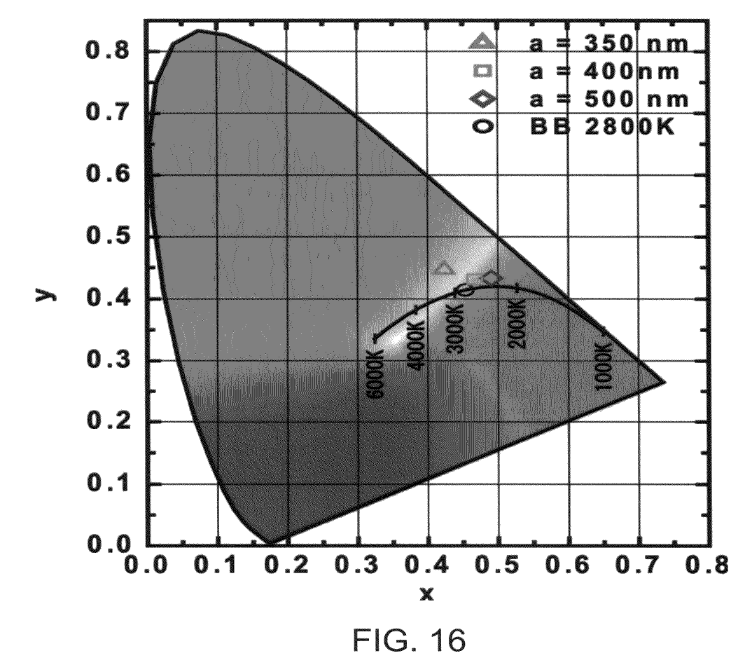

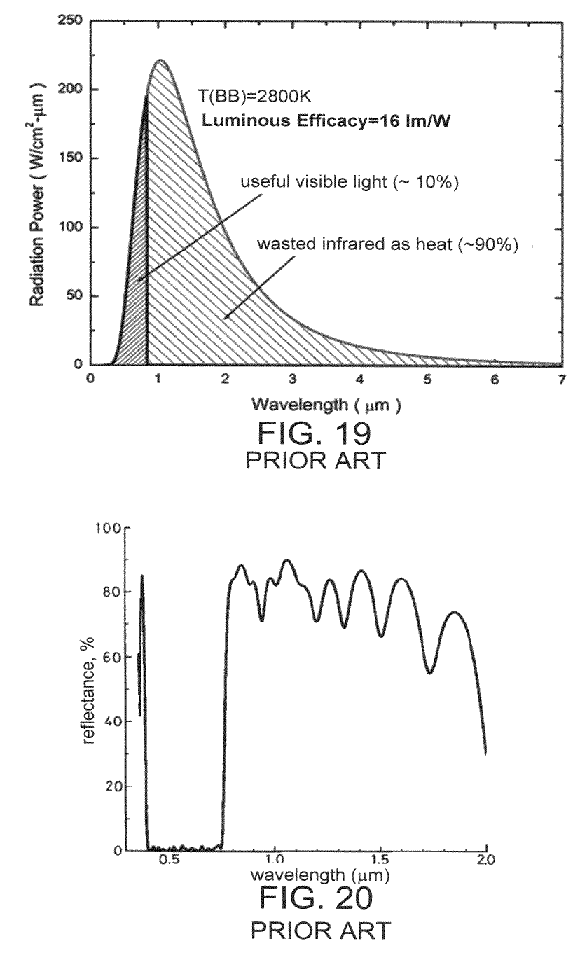

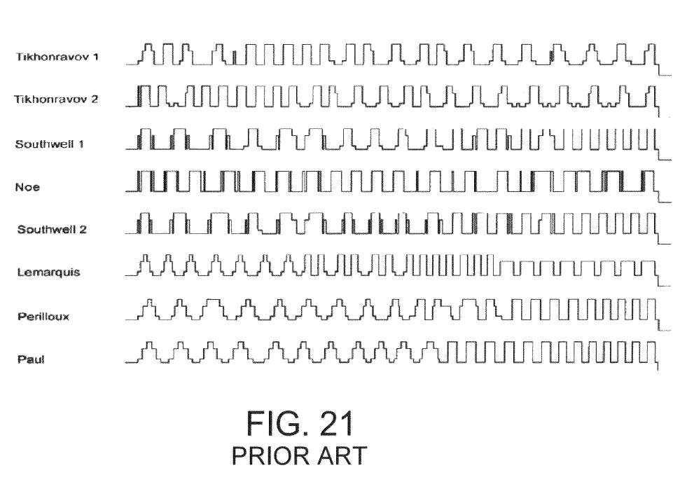

The color coordinates, a measure of color chromaticity, are calculated to be x=0.4235, y=0.4467 for a₁=350 nm, x=0.4670, y=0.4300 for a₂=400 nm, and x=0.4906, y=0.4328 for a₃=500 nm and plotted in FIG. 16. For comparison, the color coordinates of a blackbody at 2800 K are also plotted.

CRI is a measure of the ability of a light source to reproduce the true color of objects. CRI has a range between 0 and 100, with 0 indicating minimum and 100 indicating maximum color rendering capability. For example, the CRI of a blackbody radiation source is 100 and that of a standard fluorescent lamp is around 60. The CRI's of MPC filtered lights are calculated to be 68, 89, and 90 for a=350 nm, 400 nm, and 500 nm, respectively. These calculation results show that though the MPC filtered light has a lower CRI value than that of the blackbody radiation, it is still higher that that of a fluorescent lamp.

The results shown in FIGS. 14a-16 show that the performance of photon recycled incandescent source using MPC can be comparable to the currently available most efficient lighting devices.

Note that the efficiency of a photon recycled incandescent source depends on MPC characteristics including characteristics such as filling fraction, and “bar” thickness. The efficiency of converting input energy to visible light can be presented using filling fraction. The filling fraction is defined as w/a (See FIG. 1a). Calculations indicate that when the filling fraction is 25%, the maximum efficiency is achieved. To have these results, we first calculated the reflectance, transmittance and absorption of the MPC structure with an MPC filter having a structure thickness of 500 nm and the size of air void (“d” in FIG. 1a) at 380 nm (which is half of the waveguide cut-off wavelength, 780 nm, which is the maximum wavelength in visible region). Then, the efficiency is calculated, which is the ratio of output visible light power to external input power. The maximum efficiency of an MPC structure with a structure thickness of 500 nm and air void of 380 nm is calculated to be ˜42.96%.

The effects of “bar” thickness was analyzed using filling fractions of 20% and 25% and varying the thickness from 300 nm to 900 nm. The efficiencies show the maxima at around 500 nm thick at which the photonic structure is thick enough to attenuate the transmission of longer wavelengths. The maximum efficiencies are ˜41.53% for the filling fraction of 20% and ˜42.96% for the filling fraction of 25%, respectively, at the thickness of 500 nm. Comparing with the efficiency of 9.8% for a bare blackbody they have more than four times the efficiency of a bare blackbody source.

From the foregoing, it can be seen that the MPC structure used with incandescent lighting significantly improves efficiency, while retaining the desirable color rendering index of incandescent lighting. The MPC is implemented with only a single layer of square lattice or two layers of woodpile-like lattice has high reflection from the photonic band edge to infinitely long wavelength. This characteristic makes MPCs unique for use as a hot mirror. Moreover, the transmittance for visible light can be increased by engineering the geometry of the MPCs.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

We claim:

1. A method to construct an incandescent lighting structure having a filament comprising the steps of:
surrounding at least a portion of the filament with a metallic photonic crystal (MPC) filter; and
sealing the filament and metallic photonic crystal in an enclosure.

2. The method of claim 1 wherein the step of surrounding the at least a portion of the filament comprises the step of placing the MPC filter at a location such that the direction of light emitted from the filament when the filament is energized is approximately perpendicular to the MPC filter.

3. The method of claim 2 wherein the MPC filter is a flat MPC filter, the method further comprising the steps of:
placing a parabolic mirror and a spherical secondary mirror at locations such that all light emitted from the filament is approximately perpendicular to the flat MPC filter.

4. The method of claim 1 wherein the step of surrounding the at least a portion of the filament comprises surrounding the at least a portion of the filament with a MPC filter having a filling faction in the range of twenty to twenty five percent.

5. The method of claim 1 wherein the step of surrounding the at least a portion of the filament comprises surrounding the at least a portion of the filament with a MPC filter having a filling faction in the range of about twenty five percent.

6. The method of claim 1 wherein the step of surrounding the at least a portion of the filament comprises surrounding the at least a portion of the filament with a spherically shaped MPC filter.

7. The method of claim 1 wherein the step of surrounding the at least a portion of the filament comprises surrounding the at least a portion of the filament with a clyindrically shaped MPC filter.

8. The method of claim 1 wherein the step of surrounding the at least a portion of the filament further comprises surrounding the at least a portion of the filament with a spherically shaped MPC filter.

9. The method of claim 1 wherein the MPC filter has a multi-layer structure, the multi-layer structure has a number of dielectric rods to form a plurality of planar layers, the plurality of planar layers one on the other to form a multi-dimensional structure, each planar layer having a plurality of dielectric rods arranged with parallel axes at a given spacing, each planar layer having its axes oriented at an approximately ninety degree angle with respect to adjacent planar layers, and wherein the method further comprises the step of manufacturing the MPC filter by performing the steps comprising:
a) filling a plurality of grooves of an elastomeric mold with a first polymer that can be UV cured, each groove in the plurality of grooves in parallel with each other;
b) partially curing the first polymer;
c) coating a second polymer on the first polymer, resulting in a filled elastomeric mold;
d) placing one of a conducting substrate or a polymer structure on the filled elastomeric mold;
e) exposing the one of the conducting substrate or the multi-layer polymer structure and the filled elastomeric mold to UV light;
f) peeling the filled elastomeric mold away from the first polymer and the second polymer such that the first polymer and second polymer form a polymer layer of polymer rods on the one of the conducting substrate and the polymer structure;
g) forming at least a two-layer polymer structure by repeating steps a to f until a desired number of polymer layers have been formed, the at least two-layer polymer structure forming channels;
h) placing the multi-layer polymer structure in an electrolyte solution;
i) electroplating the conducting substrate and a conductive element placed above the multi-layer polymer structure such that the channels are filled with a metallic structure;
j) separating the metallic structure and multi-layer polymer structure from the conducting substrate; and
k) separating the metallic structure from the multi-layer polymer structure, thereby forming the MPC filter.

10. The method of claim 9 further comprising the step of cleaning the metallic structure.

11. The method of claim 9 wherein the conducting substrate comprises an indium-tin-oxide (ITO) coated glass and the step of separating the metallic structure and multi-layer polymer structure from the conducting substrate comprises the step of peeling the ITO coated glass away from the metallic structure and multi-layer polymer structure.

12. The method of claim 1 wherein the MPC filter has a multi-layer structure, the multi-layer structure has a number of dielectric rods to form a plurality of planar layers, the plurality of planar layers one on the other to form a multi-dimensional structure, each planar layer having a plurality of dielectric rods arranged with parallel axes at a given spacing, each planar layer having its axes oriented at an approximately ninety degree angle with respect to adjacent planar layers, and wherein the method further comprises the step of manufacturing the MPC filter by performing the steps comprising:
producing a periodic pattern on photoresist material using a laser beam;
splitting the laser beam to expose the photoresist material;
removing channels of material that have not been crosslinked by the laser to form a first layer;
backfilling empty channels in the periodic pattern of the first layer with metal;
building a second layer of periodic pattern with a ninety degree rotation from the first layer;
backfilling empty channels in the periodic pattern of the second layer with metal; and
removing the photoresist material to form the metallic photonic crystal.

13. An incandescent lighting structure comprising:
a filament in an enclosure; and
a metallic photonic crystal (MPC) filter surrounding at least a portion of the filament.

14. The incandescent lighting structure of claim 13 wherein the MPC filter is within the enclosure.

15. The incandescent lighting structure of claim 13 wherein the MPC filter is an approximately flat MPC filter, the incandescent lighting structure further comprising a parabolic mirror and a secondary mirror placed at locations such that all light emitted from the filament is approximately perpendicular to the flat MPC filter.

16. The incandescent lighting structure of claim 13 wherein the MPC filter is placed at a location such that the direction of light emitted from the filament is approximately perpendicular to the MPC filter.

17. The incandescent lighting structure of claim 13 wherein the MPC filter has a filling fraction of about twenty five percent.

18. The incandescent lighting structure of claim 13 wherein the MPC filter is one of spherically shaped or cylindrically shaped.

19. The incandescent lighting structure of claim 13 wherein the MPC filter has a multi-layer structure, the multi-layer structure has a number of dielectric rods to form a plurality of planar layers, the plurality of planar layers one on the other to form a multi-dimensional structure, each planar layer having a plurality of dielectric rods arranged with parallel axes at a given spacing, each planar layer having its axes oriented at an approximately ninety degree angle with respect to adjacent planar layers

20. The incandescent lighting structure of claim 13 wherein the MPC filter has a two layer structure.
